(19) United States
(12) Patent Application Publication
(10) Pub. No.: US 2022/0155454 A1
(43) Pub. Date: May 19, 2022

(54) ANALYSIS PORTION, TIME-OF-FLIGHT IMAGING DEVICE AND METHOD

(71) Applicant: Sony Semiconductor Solutions Corporation, Kanagawa (JP)

(72) Inventors: Valerio Cambareri, Brussels (BE); Luca Cutrignelli, Brussels (BE); Rachit Mohan, Stuttgart (DE)

(73) Assignee: Sony Semiconductor Solutions Corporation, Kanagawa (JP)

(21) Appl. No.: 17/439,358

(22) PCT Filed: Mar. 20, 2020
(86) PCT No.: PCT/EP2020/057796

§ 371 Date: Sep. 14, 2021

(30) Foreign Application Priority Data
Mar. 22, 2019 (EP) 19164581.1

(51) Int. Cl. G01S 17/894; G06T 7/521

(52) U.S. Cl. CPC G01S 17/894; G06T 2207/20081; G06T 2207/10028; G06T 7/521

(57) ABSTRACT

The present disclosure pertains to an analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, configured to: construct first imaging data of the at least one imaging element of the first type based on second imaging element data of the at least one imaging element of the second type, wherein the first imaging data are constructed based on a machine learning algorithm.

### TECHNICAL FIELD

The present disclosure generally pertains to an analysis portion for a time-of-flight imaging portion, a time-of-flight imaging device and a method for controlling a time-of-flight imaging portion.

### TECHNICAL BACKGROUND

Generally, time-of-flight (ToF) devices are known, for example for imaging or creating depth maps of a scene, such as an object, a person, or the like. It can be distinguished between direct ToF (dToF) and indirect ToF (iToF) for measuring a distance either by measuring the run-time of emitted and reflected light (dToF) or by measuring one or more phase-shifts of emitted and reflected light (iToF).

In order to measure a distance, known time of flight devices need to traverse thousands or millions of measurement cycles, which can result in a time consuming process. Moreover, in order to reduce the number of measurement cycles while maintaining a complex imaging chip which is able to also acquire information apart from depth/distance information, such as color information, complex algorithms have to be found for demosaicking raw imaging data.

Therefore, it is generally desirable to provide an analysis portion for a time-of-flight imaging portion, a time-of-flight imaging device and a method for controlling an analysis portion for time-of-flight imaging portion.

### SUMMARY

According to a first aspect the disclosure provides an analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, wherein the analysis portion is configured to: construct first imaging data of the at least one imaging element of the first type based on second imaging element data of the at least one imaging element of the second type, wherein the first imaging data are constructed based on a machine learning algorithm.

According to a second aspect the disclosure provides a time-of-flight imaging device comprising a time-of-flight imaging portion including at least one imaging element of a first type and at least one imaging element of a second type, wherein the at least one imaging element of the first type and the at least one imaging element of the second type are arranged in a predetermined pattern; and an analysis portion for the time-of-flight imaging portion, configured to: construct first imaging data of the at least one imaging element of the first type based on second imaging element data of the at least one imaging element of the second type, wherein the first imaging data are constructed based on a machine learning algorithm.

According to a third aspect the disclosure provides a method for controlling an analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, the method comprising: constructing first imaging data of the at least one imaging element of the first type based on second imaging element data of the at least one imaging element of the second type, wherein the first imaging data are constructed based on a machine learning algorithm.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 shows six embodiments of ToF imaging portions;

FIG. 2 shows an embodiment of a ToF imaging device;

FIG. 3 shows a method for constructing imaging data;

FIG. 4 shows a representation of mosaicked raw data;

FIG. 5 shows a first example of first and second imaging data and output data;

FIG. 6 shows a second example of first and second imaging data and output data;

FIG. 7 is a perspective view depicting a first example of an external configuration of a stacked image sensor;

FIG. 8 is a perspective view depicting a second example of an external configuration of a stacked image sensor;

FIG. 9 is a block diagram depicting a configuration example of peripheral circuits;

FIG. 10 is an abstract diagram of an embodiment of a time-of-flight device; and

FIG. 11 shows a flow-chart of an embodiment of a method according to the present disclosure.

### DETAILED DESCRIPTION OF EMBODIMENTS

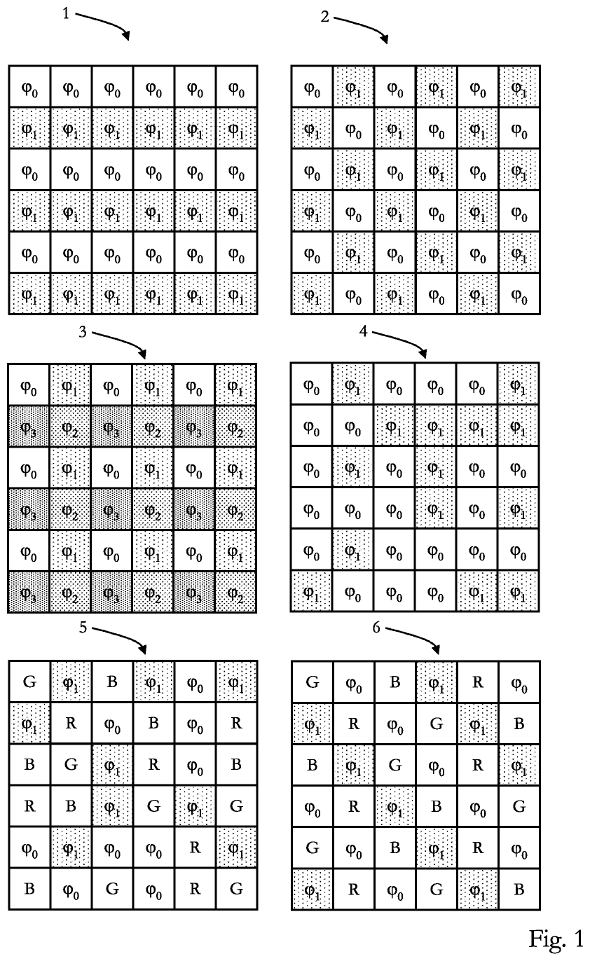

Before a detailed description of the embodiments under reference of FIG. 1 is given, general explanations are made.

As already explained in the outset, it may be generally desirable to have a small number (e.g. one) of imaging cycles. It has been recognized that, therefore, complex algorithms have to be found in order to be able to demosaick raw imaging data, which is acquired in a small number of imaging cycles.

Therefore, some embodiments pertain to an analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, wherein the analysis portion is configured to: construct first imaging data of the at least one imaging element of the first type based on second imaging element data of the at least one imaging element of the second type, wherein the first imaging data are constructed based on a machine learning algorithm.

In general, the analysis portion may be provided by (any) circuitry configured to perform the methods as described herein, such as any device, chip, or the like, which can be configured to analyze (imaging) data, or the like, and the portion may include one or more processors, circuits, circuitries, etc., which may also be distributed in the time of flight device or imaging portion. For example the analysis portion (circuitry) may be a processor, such as a CPU (Central Processing Unit), GPU (Graphic Processing Unit), FPGA (Field Programmable Gate Array), or the like, or several units of CPU, GPU, FPGA (also in combination). In other embodiments, the analysis portion (circuitry) is a (personal) computer, a server, an AI accelerator, or the like.

The time-of-flight imaging portion may be implemented as a camera, for example, as a standalone device, or it may be combined with other camera techniques in order to create a depth map. The time-of-flight apparatus may also be included or integrated in another device, such as a smartphone, tablet, handheld computer, a camera system, or the like.

Generally, the present technology may also be implemented any technical field, where time-of-flight technology is used, such as automotive technology, traffic systems, or the like.

Embodiments of the time-of-flight imaging portion may be based on different time-of-flight (ToF) technologies. Generally, ToF devices may be grouped into two main technologies, namely indirect ToF (iToF) and direct ToF (dToF), as indicated above.

A time-of-flight imaging portion, which may be based on iToF technology, indirectly obtains the depth measurements by recovering the phase of a correlation wave, which is indicative of a phase shift between a modulated emitted light and the light received from being reflected by a scene. The analysis portion, e.g. configured in an iToF pixel sensor or as a portion reading a signal from an iToF pixel sensor, demodulates illumination modulation cycles reflected from the scene for sampling the correlation wave (between the emitted modulated light signal and the received demodulated light signal or signals which are indicative of them), which is based on correlation obtained by correlating emitted and detected light.

In some embodiments, the time-of-flight imaging portion, which is based on the dToF technology, directly obtains the depth measurements by measuring the time-of-flight of the photons emitted by a light source and reflected from the scene, e.g. based on hundreds of short illumination pulses emitted.

In general, an imaging element may be based on any type of known sensing technology for time-of-flight systems and may be based on, for example, CMOS (complementary metal-oxide semiconductor), CCD (charge coupled device), SPAD (single photon avalanche diode), CAPD (current assisted photodiode) technology, or the like, wherein SPADs may be used for dToF based technologies and CAPDs may be used for iToF based technologies.

Moreover, the time-of-flight imaging portion may include an imaging element, e.g. a single pixel, or multiple imaging elements, e.g. multiple pixels, which may be arranged in an array, a pattern, or the like, as it is generally known. The ToF imaging portion, in particular, may have a small number of imaging elements (pixels) (e.g. 64 by 64 pixels), but in other embodiments, the number of pixels may be smaller (e.g. 32×32, 16×16, 16×32, etc.) or larger (e.g. 128×128 pixels, 128×256, 256×256, etc.).

The imaging elements may also be grouped, for example, into predetermined groups of imaging elements (for example four, eight, or the like), which are specifically arranged, for example in a row, in a column, in a square, in a rectangle or the like.

In some embodiments, the predetermined group of imaging elements may share a circuitry which, for example, is configured to read out information produced by the imaging elements, such as the analysis portion. Moreover, in some embodiments, one imaging element includes two or more pixels, which may share a circuitry for reading out the pixel information.

The imaging element of the first type and the imaging element of the second type may generally be imaging elements that serve the same purpose. For example, as mentioned above, both imaging elements may be used for measuring a phase of a correlation wave. In these embodiments, the imaging element of the first type and the imaging element of the second type may be each iToF pixel sensors being indicative of phase information, wherein a signal caused by the imaging element of the first type (i.e. first imaging element data) may be indicative of a first phase information and a signal caused by the imaging element of the second type (i.e. second imaging element data) may be indicative of a second phase information. In other embodiments, the imaging element of the first type and the imaging element of the second type serve different purposes. For example, the imaging element of the first type may provide information (first imaging element data), which is indicative for a phase, whereas the imaging element of the second type may provide information (second imaging element data) which is indicative for a color or any other signal from a light spectrum, such as infrared, ultraviolet, or the like.

As mentioned above, in some embodiments the at least one imaging element of the first type and the at least one imaging element of the second type are arranged in a predetermined pattern.

The arrangement may be based on a manufacturing process, such as the production of a chip for a time-of-flight imaging portion, or the like. In other embodiments, the arrangement may be stipulated after the manufacturing process. For example, in embodiments, which include imaging elements indicative of a phase, it may be determined after manufacturing which imaging element is assigned to which phase, for example by cabling or programming of the imaging element.

In this context, an arranged pattern may be predetermined. The pattern may be a row wise arrangement of two or more phases, colors, or the like, a checkerboard type arrangement of two phases, colors, or the like, a grid like arrangement (such as a quincunx grid) of two or more phases, colors, or the like, a random pattern (e.g. generated with a random generator, or the like) of at least two phases, colors, or the like, or any other regular or irregular pattern.

The pattern may be (dynamically) chosen depending on an imaging situation (e.g. dark, bright, or the like) or depending on a scene (e.g. much movement).

The constructing of first imaging data may refer to an algorithm, a program, or the like which processes imaging data in order to generate new imaging data. In this context, in some embodiments the at least one imaging element of the first type and the at least one imaging element of the second type are driven alternatively, i.e. while the at least one imaging element of the second type is turned on or modulated and acquires second imaging element data, the at least one imaging element of the first type is turned off. This leads to missing first imaging data, which in turn leads to, for example, an image with missing pixels, i.e. missing information from pixels which are of the other type.

Therefore, based on second imaging element data first imaging data are constructed.

Thereby, the missing imaging data may be acquired.

The construction is based on a machine learning algorithm. In some embodiments, an algorithm which is derived from a machine learning process is applied to second imaging element data in order to construct first imaging data. Different machine learning algorithms may be applied in order to construct the first imaging data, such as supervised learning, semi-supervised learning, unsupervised learning, reinforcement learning, feature learning, sparse dictionary learning, anomaly detection learning, decision tree learning, association rule learning, or the like.

The machine learning algorithm may further be based on at least one of the following: Feature extraction techniques, classifier techniques or deep-learning techniques. Feature extraction may be based on at least one of: Scale Invariant Feature Transfer (SIFT), Cray Level Co-occurrence Matrix (GLCM), Gaboo Features, Tubeness or the like. Classifiers may be based on at least one of: Random Forest; Support Vector Machine; Neural Net, Bayes Net or the like. Deep learning may be based on at least one of: Autoencoders, Generative Adversarial Network, Weakly Supervised Learning, Boot-Strapping or the like.

Thereby, an approach may be found for constructing the first/second imaging data for the “missing pixels of the other type”.

In some embodiments, the algorithm may be hardcoded on the analysis portion, i.e. the machine learning algorithm may provide an image processing algorithm, a function, or the like, which is then provided at a chip, such as a GPU, FPGA, CPU, or the like, which may save processing capacity in-stead of storing an artificial intelligence on a time-of-flight imaging portion.

However, in other embodiments, the machine learning algorithm may be developed and/or used by an (strong or weak) artificial intelligence (such as a neural network, a support vector machine, a Bayesian network, a genetic algorithm, or the like) which constructs the first imaging data, which, in some embodiments, makes it possible that the algorithm may be adapted to a situation, a scene, or the like.

In some embodiments, the analysis portion is further configured to construct second imaging data of the at least one imaging element of the second type based on first imaging element data of the at least one imaging element of the first type, wherein the first imaging element data correspond to imaging data of a first modulation phase and the second imaging element data correspond to imaging data of a second modulation phase, as described above. The modulation phases may refer to indirect ToF as discussed above and as generally known to the skilled person.

The second imaging data may be constructed similarly as the first imaging data are constructed, wherein the at least one imaging element of the second type is turned off while the at least one imaging element of the first type is driven, as already described herein (for the case that the first type and second type imaging elements refer to different modulation phases. However, in some embodiments, the elements are driven simultaneously and the phase shift, i.e. the different modulation phases, may be caused by other measurements, e.g. controlling a light source and shutters for the different imaging elements accordingly).

However, other algorithms or other parameters may be used in order to construct the second imaging data, than the algorithms or parameters used for constructing the first imaging data.

In some embodiments the time-of-flight imaging portion includes at least one imaging element of a third type, which is included in the predetermined pattern, the analysis portion is further configured to: construct third imaging data of the at least one imaging element of the third type based on any of the first imaging element data or the second imaging element data, wherein the third imaging data indicate color information.

As already described above, the at least one imaging element of the third type may refer to color information. Hence, a third type may refer to exactly one type corresponding to a specific color (note that herein color may refer to any wavelength of the electromagnetic spectrum irrespective of its visibility to the human eye, such as infrared light, ultraviolet light or any other kind of electromagnetic radiation), for example red, or to a plurality (at least two) colors. For example, there may be a third, a fourth, and a fifth type of imaging elements, such as red, blue and green, acquiring imaging data of the respective colors. Also, there may be a multispectral image sensor, or the like.

In other embodiments, there may be at least one imaging element of a third type and at least one imaging element of a fourth type, both acquiring additional phase information.

By providing the at least one imaging element of the third type, it is possible to improve an image quality and/or to acquire a more complex image. For example, by providing at least one imaging element of a third type and at least one imaging element of a fourth type, a signal to noise ratio may be increased. On the other hand, image complexity may be increased by having additional color information.

In other embodiments, a plurality of imaging elements acquiring phase information are combined with a plurality of imaging elements acquiring color information (for example, two phases and three colors, four phases and three colors, or the like).

Third imaging data may, in this context, be a summarization of different imaging data, such as third and fourth phase information, third and fourth phase information and first to third color information, or the like.

The constructing of the third imaging data may be similar to the constructing of the first and second imaging data, hence the third imaging data may be constructed out of the first and/or the second imaging element data. Also, in some embodiments, the first imaging data may be constructed based on the second and/or third imaging element data and the second imaging data may be constructed based on the first and/or the third imaging element data. In specific, color information may be constructed based on phase information or phase information may be constructed based on color information.

In some embodiments, the machine learning algorithm is applied to a neural network, as already described.

In some embodiments, the neural network is trained based on the predetermined pattern. The predetermined pattern may be hardcoded in the machine learning algorithm. Also, ground-truth data (i.e. reference data for the machine learning algorithm) may be provided to the machine learning algorithm, such as a ToF image which has desired properties, e.g. low noise, high resolution, or the like in order to learn to construct the first/second imaging data.

In some embodiments, a function or an algorithm obtained by the machine learning algorithm for constructing the first (or second, or third) imaging data are provided at the analysis portion, as already described above.

In some embodiments, the first imaging data and the second imaging data are constructed in response to one exposure of the time-of-flight imaging portion. In this context, the time-of-flight imaging portion may be modulated for only one imaging cycle and, for example, only first imaging data are acquired, whereas second and/or third imaging data are constructed based on the first imaging data.

Also, in some embodiments, first and second (and third) imaging data may be acquired within one exposure by having two (three) modulation cycles within one exposure, such that a minimum number of exposures (e.g. one) is achieved.

Some embodiments pertain to a time-of-flight imaging device comprising: a time-of-flight imaging portion including at least one imaging element of a first type and at least one imaging element of a second type, wherein the at least one imaging element of the first type and the at least one imaging element of the second type are arranged in a predetermined pattern, as described herein; and an analysis portion for the time-of-flight imaging portion, configured to: construct first imaging data of the at least one imaging element of the first type based on second imaging element data of the at least one imaging element of the second type, wherein the first imaging data are constructed based on a machine learning algorithm, as described herein.

In some embodiments, the time-of-flight imaging portion and the analysis portion are stacked onto each other. Moreover, in some embodiments, a memory, if not included in the time-of-flight imaging portion or the analysis portion, may additionally be stacked onto the analysis portion, onto the time-of-flight imaging portion, or between the analysis portion and the time-of-flight imaging portion.

By providing a stacked configuration, compared to a side-by-side configuration, a size of a produced chip may be reduced, signal pathways may be shortened, or the like.

In some embodiments, the predetermined pattern corresponds to an alternating arrangement of the at least one imaging element of the first type and the at least one imaging element of the second type. As already described above, an alternating arrangement may be a row wise, checkerboard like, grid like arrangement, or the like, depending on the situation or the scene.

In some embodiments, the predetermined pattern is a random pattern, as described herein.

In some embodiments, the time-of-flight imaging device further includes at least one imaging portion of a third type included in the predetermined pattern indicating a color information, as described herein.

Some embodiments pertain to a method for controlling an analysis portion for a time-of-flight imaging portion (or circuitry, device, or the like, as described herein), wherein the time-of-flight imaging portion includes at least one imaging element of a first type and at least one imaging element of a second type, wherein the at least one imaging element of the first type and the at least one imaging element of the second type are arranged in a predetermined pattern, the method including: constructing first imaging data of the at least one imaging element of the first type based on second imaging element data of the at least one imaging element of the second type, wherein the first imaging data are constructed based on a machine learning algorithm, as described herein.

In some embodiments, the method further includes constructing second imaging data of the at least one imaging element of the second type based on first imaging element data of the at least one imaging element of the first type, wherein the first imaging element data correspond to imaging data of a first modulation phase, and wherein the second imaging element data correspond to imaging data of a second modulation phase, as described herein.

In some embodiments, the time-of-flight imaging portion includes at least one imaging element of a third type, which is included in the predetermined pattern, the method further includes: constructing third imaging data of the at least one imaging element of the third type based on any of the first imaging element data or the second imaging element data, wherein at least the third imaging data indicates color information, or wherein any of the first imaging data or the second imaging data are further constructed based on third imaging element data, as described herein.

In some embodiments, the machine learning algorithm is applied to a neural network, as described herein.

In some embodiments, the neural network is trained based on the predetermined pattern, as described herein

In some embodiments, a function obtained by the machine learning algorithm for constructing the first imaging data and the second imaging data are provided at the analysis portion, as described herein.

In some embodiments, the first imaging data and the second imaging data are constructed in response to one exposure of the time-of-flight imaging portion, as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, six embodiments of ToF imaging portions are shown. In each of these embodiment, and also in other embodiments, the pattern is predetermined, i.e. hardcoded into a training algorithm of an artificial intelligence.

In the embodiment referred to with reference sign 1, there is shown an alternate, row wise arrangement of imaging elements of the first type and imaging elements of the second type for the acquisition of phase information for the two phases φ₀ and φ₁.

In the embodiment referred to with reference sign 2, there is shown an alternating, quincunx grid arrangement of imaging elements of the first type and imaging elements of the second type for the acquisition of phase information for the two phases φ₀ and φ₁.

In other embodiments, an alternating arrangement also refers to a column wise arrangement. Also, alternating arrangement may refer to other kinds of regular arrangement of imaging elements, such as two imaging elements of the first type and one imaging element of the second type (or other combinations), either row wise, column wise, diagonal, or the like.

In the embodiment referred to with reference sign 3, there is shown a repetition of a grid wise arrangement of imaging elements of four types each acquiring phase information φ₀, φ₁, φ₂, and φ₃.

In the embodiment referred to with reference sign 4, there is shown an irregular (random) pattern of imaging elements of two types φ₀ and φ₁.

An irregular (random) pattern of phase information acquiring imaging elements of two types and three color acquiring imaging elements R (red), G (green), and B (blue) is shown in the embodiment with reference sign 5.

In the embodiment referred to with reference sign 6, there is shown a regular pattern of two phase acquiring pixels φ₀ and φ₁ and three color acquiring pixels R, G and B.

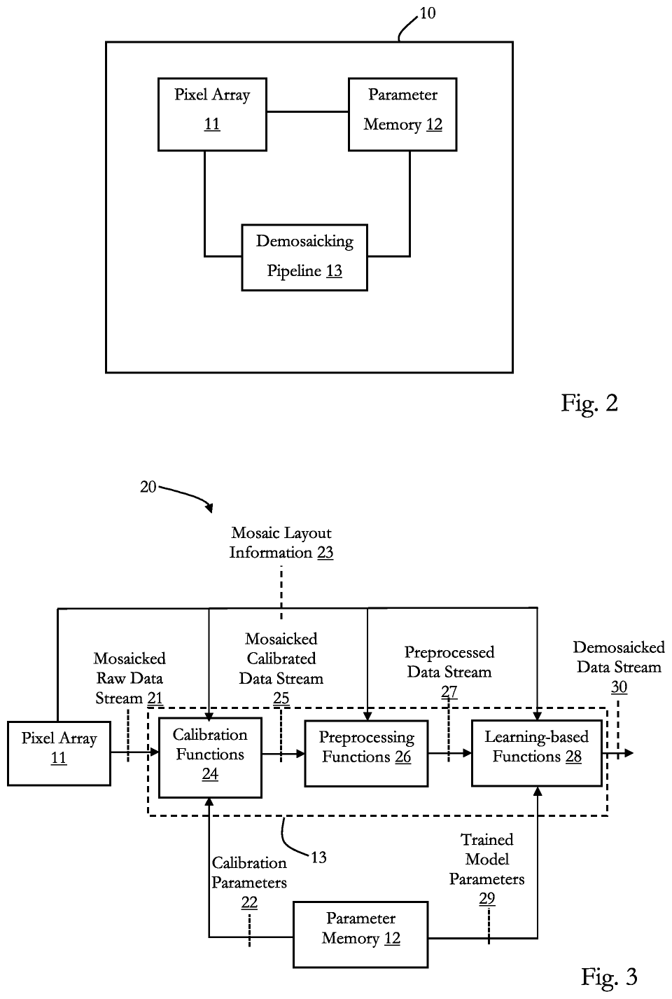

FIG. 2 shows an embodiment of a time-of-flight imaging device 10 according to the present disclosure. The time-of-flight imaging device 10 includes a pixel array 11, corresponding to a time-of-flight imaging portion such as one of the time-of-flight imaging portions of FIG. 1. The time-of-flight imaging device 10 further includes a parameter memory 12 and a demosaicking pipeline 13.

In other embodiments, the pixel array 11 may further include auxiliary imaging elements (pixels), such as infrared pixels acquiring image information of the infrared light spectrum, other color filters, or the like.

The parameter memory 12 stores or calculates calibration data and learning hyperparameters. The calibration data includes a characterization of the pixel array 11, i.e. the distribution and type of pixels, offset data, gain data, and auxiliary information (e.g. a confidence). The memory also stores parameters for the operation of the demosaicking pipeline 13, such as parameters for the signal processing to obtain a depth map. The parameters included in the parameter memory 12 include machine learning parameters, which are learned from a given dataset (such as the calibration data).

The machine learning parameters are obtained by training. Therefore, ground-truth data are captured with the time-of-flight imaging device 10 at predetermined conditions (such as conditions which minimize noise, specific temperature, or the like) in a calibration mode which is different from the mode of operation as described herein and corresponds to a known mode of operation. The ground-truth data corresponds to a full-resolution raw ToF image. Then, the time-of-flight imaging device 10 is operated as explained herein, acquiring first and/or second and/or third imaging data (based on the predetermined pattern of the pixel array, which is hardcoded into the training) and a machine learning algorithm is applied for mapping the first and/or the second and/or third imaging data to the ground-truth data in order to find machine learning parameters to construct a final image out of the first, second and/or third imaging data, as explained herein.

The found machine learning parameters are then written into the parameter memory 12 and are re-called when the machine learning algorithm is applied in order to correct the parameters (depending on the situation).

In this embodiment, the demosaicking pipeline 13 corresponds to the analysis portion, as described herein. However, in other embodiments, the analysis portion includes the parameter memory 12 and the demosaicking pipeline 13. The demosaicking pipeline 13 is based on a machine learning engine which is capable of performing signal processing tasks. The demosaicking pipeline receives raw ToF data from the pixel array 11 and auxiliary data from the parameter memory 12.

The demosaicking pipeline constructs imaging data from the pixel array based on the found algorithm, as explained herein.

The demosaicking pipeline is further explained under reference of FIG. 3.

FIG. 3 illustrates a method 20 for constructing imaging data.

In response to an acquisition of the pixel array 11, in 21, mosaicked raw data (including first/second/third imaging data), is transmitted from the pixel array 11 to the demosaicking pipeline 13. Moreover, in 22, calibration parameters are transmitted from the parameter memory 12 to the demosaicking pipeline. Calibration parameters include, for example, pixel value offsets and gains.

In 23, mosaic layout information (including the predetermined pattern and the types of imaging elements) is transmitted from the pixel array 11 to the demosaicking pipeline 13.

In 24, calibration functions, which include the calibration parameters and the mosaic layout information are applied to the mosaicked raw data, generating mosaicked calibrated data, which is output in 25.

The calibration functions further include functions to remove noise, correct non-idealities in phase response, such as gain removal.

In 26, preprocessing functions, which include the mosaic layout information are applied to the mosaicked calibrated data, thereby generating preprocessed data which is output in 27.

The preprocessing functions further include normalization functions, upscaling functions, computation functions determining intermediate data, which is useful for the learning-based functions, such as nearest neighbor interpolation, stacking and normalization of the input.

In 28, learning based function are applied to the preprocessed data. The learning based functions include the mosaic layout information and trained model parameters, which are transmitted to the demosaicking pipeline 13 by the parameter memory 12 in 29. By applying the learning based functions and a forward-pass algorithm to the preprocessed data, demosaicked data are generated, which is output in 30.

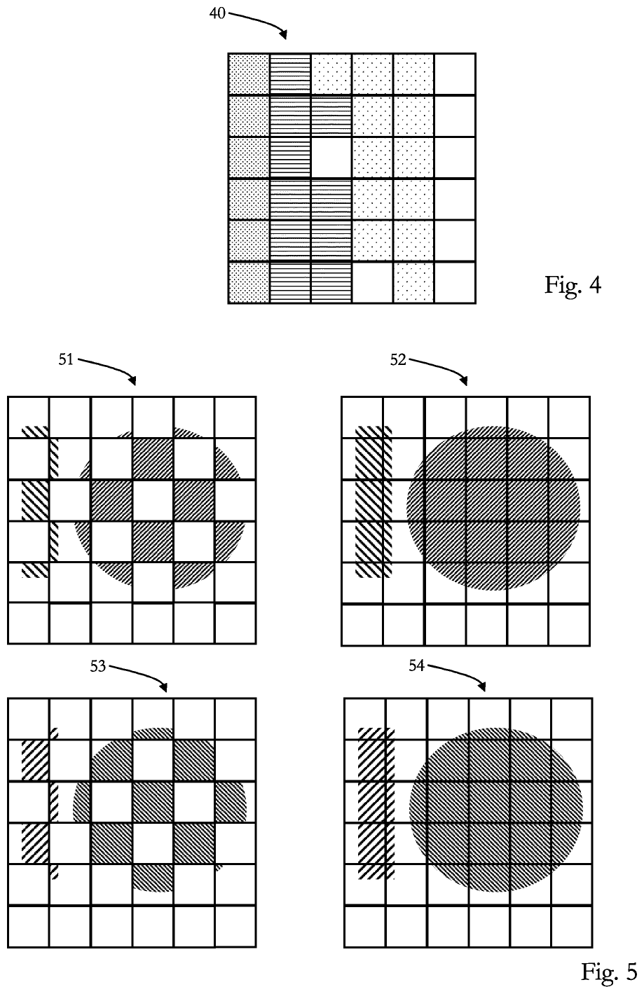

FIG. 4 shows a representation of mosaicked raw data 40 as transmitted in 21 of FIG. 3 which is acquired with the time-of-flight imaging portion of the embodiment with reference sign 3 of FIG. 1.

Thus, the mosaicked raw data corresponds to imaging signals as they are acquired with the respective imaging elements of embodiment 3. Different hachures of the imaging elements represent different depth information.

FIG. 5 shows a first example of first imaging data 51 acquired with the time-of-flight imaging portion of embodiment 2, wherein only the imaging elements go acquire a signal and second imaging data are constructed based on the first imaging data, as shown in 52, which corresponds to the demosaicked data 30 of FIG. 3.

Moreover, FIG. 5 shows a representation of second imaging data 53 acquired with the time-of-flight imaging portion of embodiment 2, wherein only the imaging elements 91 acquire a signal and first imaging data are constructed based on the second imaging data, as shown in 54, which corresponds to the demosaicked data 30 of FIG. 3.

In FIG. 5, as in FIG. 4, different hachures correspond to different depth information. It should be recognized that the hachures of 51 and 52 differ from the hachures of 53 and 54, although the same scene is displayed. The reason for that is that the respective depth information is relative to a predetermined reference value, which is different in the two cases. However, the combination of the phase information of the two images 52 and 54 allows to normalize the reference value and generate a unified output.

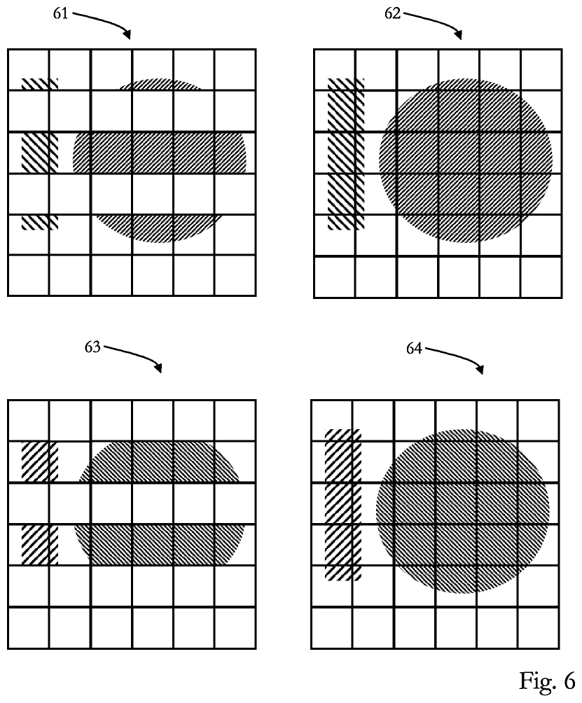

FIG. 6 shows a second example of first imaging data 61 acquired with the time-of-flight imaging portion of embodiment 1, wherein only the imaging elements go acquire a signal and second imaging data are constructed based on the first imaging data, as shown in 62.

Moreover, FIG. 6 shows a representation of second imaging data 63 acquired with the time-of-flight imaging portion of embodiment 1, wherein only the imaging elements 91 acquire a signal and first imaging data are constructed based on the second imaging data, as shown in 64.

Therefore, FIG. 6 mainly corresponds to what is displayed in FIG. 5, but with another time-of-flight imaging portion.

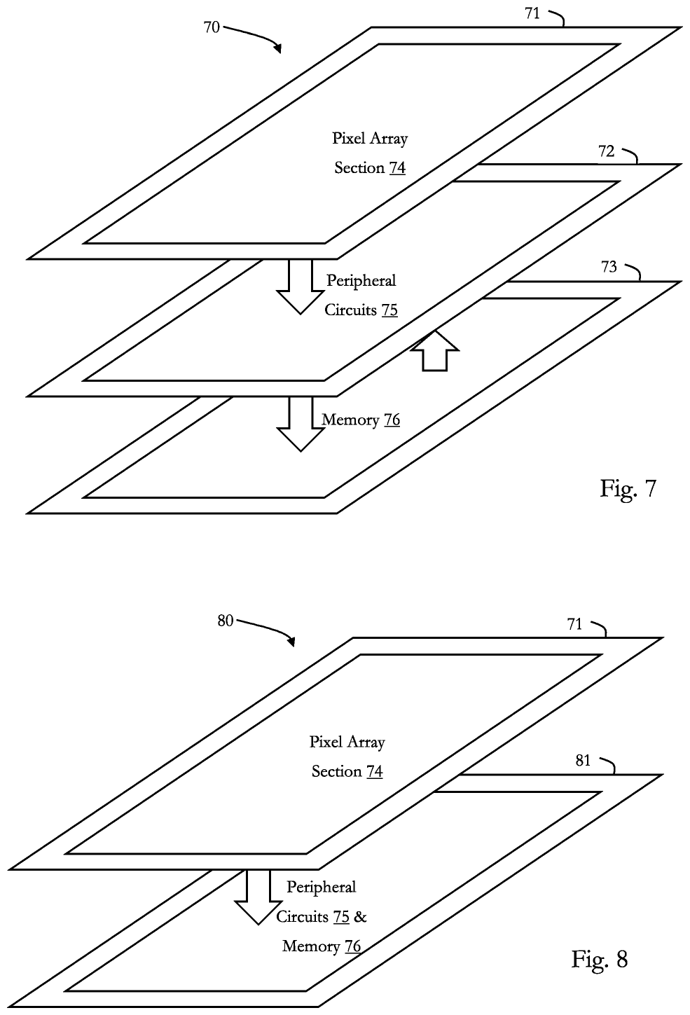

FIG. 7 is a perspective view depicting a first example of a external configuration of a stacked image sensor 70 to which the present technology is applied.

The image sensor may be a complementary metal oxide semiconductor (CMOS) image sensor, for example. This is a three-layer structure image sensor. That is, the image sensor is made up of (semi-conductor) substrates 71, 72 and 73 stacked in that order from the top down.

The substrate 71 has a pixel array section 74 formed thereon. The pixel array section 74 is configured to perform photoelectric conversion and have multiple pixels (not depicted) arrayed in a matrix pattern to output a pixel signal each, as described herein.

The substrate 72 has peripheral circuits 75 formed thereon. The peripheral circuits 75 perform various kinds of signal processing such as AD conversion of pixel signals output from the pixel array section 74. Moreover, the peripheral circuits 75 include a demosaiking pipeline, as described herein.

The substrate 73 has a memory 76 formed thereon. The memory 76 functions as a storage section that temporarily stores pixel data resulting from the AD conversion of the pixel signals output from the pixel array section 74. Moreover, the memory 76 includes the parameter memory, as described herein.

FIG. 8 depicts a second configuration example of the stacked image sensor 80.

Of the components in FIG. 8, those whose corresponding counterparts are found in FIG. 7 are designated by like reference numerals, and their explanations are be omitted hereunder where appropriate.

The image sensor 80, like its counterpart 70 of FIG. 7, has the substrate 71. It is to be noted, however, that the image sensor 80 differs from the image sensor 70 in that a substrate 81 is provided in place of the substrates 72 and 73.

The image sensor 80 has a two-layer structure. That is, the image sensor has the substrates 71 and 81 stacked in that order from the top down.

The substrate 81 has the peripheral circuits 75 and the memory 76 formed thereon.

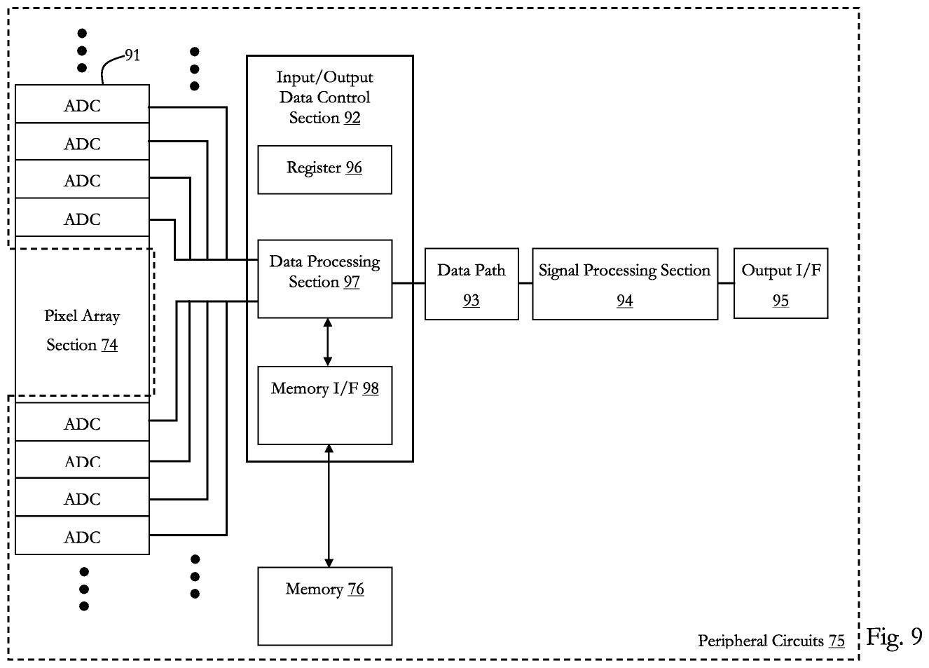

FIG. 9 is a block diagram depicting a configuration example of peripheral circuits 75 in FIGS. 7 and 8.

The peripheral circuits 75 include multiple AD (analog-to-digital) converters (ADCs) 91, an m-put/output data control section 92, a data path 93, a signal processing section 94, and an output interface (I/F) 95.

There are the same number of ADCs 91 as the columns of pixels constituting the pixel array section 74. The pixel signals output from the pixels arrayed in each line (row) are subjected to parallel-column AD conversion involving parallel AD conversion of the pixel signals. The input/output data control section 92 is supplied with pixel data of a digital signal obtained per line by the ADCs 91 subjecting the pixel signals as analog signals to parallel-column AD conversion.

The input/output data control section 92 controls the writing and reading of the pixel data from the ADCs 91 to and from the memory 76. The input/output data control section 92 also controls the output of the pixel data to the data path 93.

The input/output data control section 92 includes a register 96, a data processing section 97, and a memory I/F 98.

Information with which the input/output data control section 92 controls its processing is set (recorded) to the register 96 under instructions from an external device. In accordance with the information set in the register 96, the input/output data control section 92 performs various kinds of processing.

The data processing section 97 outputs the pixel data from the ADCs 91 directly to the data path 93.

Alternatively, the data processing section 97 may perform necessary processing on the pixel data supplied from the ADCs 91, before writing the processed pixel data to the memory 76 via the memory I/F 98.

Furthermore, the data processing section 97 reads via the memory I/F 98 the pixel data written in the memory 76, processes the retrieved pixel data from the memory 76 as needed, and outputs the processed pixel data to the data path 93.

Whether the data processing section 97 outputs the pixel data from the ADCs 91 directly to the data path 93 or writes the pixel data to the memory 76 may be selected by setting suitable information to the register 96.

Likewise, whether or not the data processing section 97 processes the pixel data fed from the ADCs 91 may be determined by setting suitable information to the register 96.

The memory I/F 98 functions as an I/F that controls writing and reading of pixel data to and from the memory 76.

The data path 93 is made up of signal lines acting as a path that feeds the pixel data output from the input/output data control section 92 to the signal processing section 97.

The signal processing section 94 performs signal processing such as black level adjustment, demosaicking, white balance adjustment, noise reduction, developing, or other signal processing, as described herein, as needed on the pixel data fed from the data path 93, before outputting the processed pixel data to the output I/F 95.

The output I/F 95 functions as an I/F that outputs the pixel data fed from the signal processing section 95 to the outside of the image sensor.

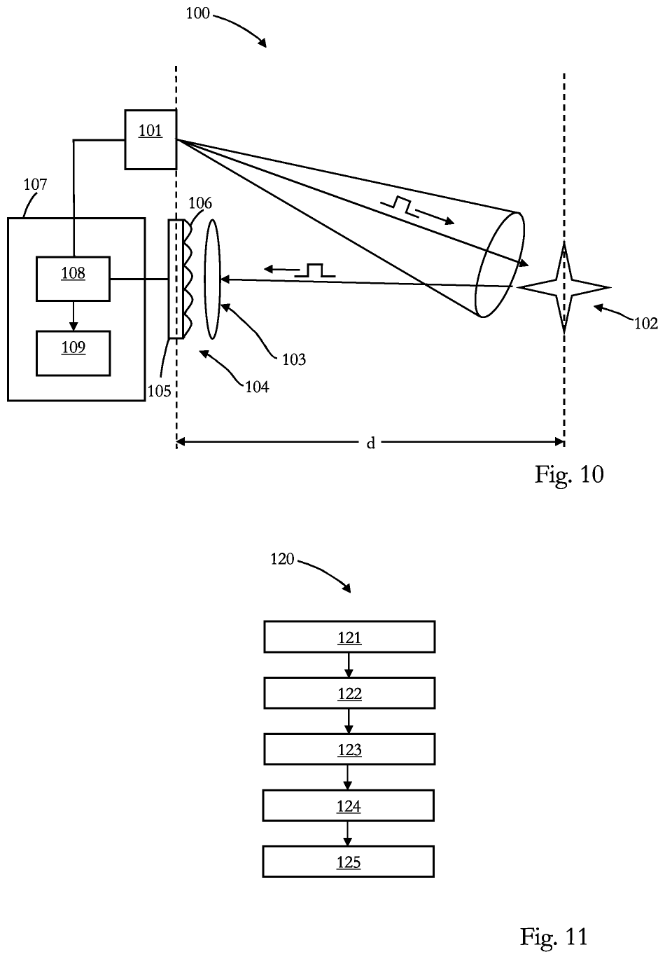

Referring to FIG. 10, there is illustrated an embodiment of a time-of-flight (ToF) device 100, which can be used for depth sensing or providing a distance measurement, in particular for the technology as discussed herein, wherein the ToF device 100 is configured as an iToF camera. The ToF device 100 has a circuitry 107 which is configured to perform the methods as discussed herein and which forms a control of the ToF device 100 (and it includes, not shown, corresponding processors, memory and storage as it is generally known to the skilled person, and an analysis portion, as discussed herein).

The ToF device 100 has a continuous light source 101 and it includes light emitting elements (based on laser diodes), wherein in the present embodiment, the light emitting elements are narrow band laser elements.

The light source 101 emits light, i.e. modulated light, as discussed herein, to a scene 102 (region of interest or object), which reflects the light. The reflected light is focused by an optical stack 103 to a light detector 104.

The light detector 104 has an time-of-flight imaging portion, as discussed herein, which is implemented based on multiple CAPDs formed in an array of pixels and a microlens array 106 which focuses the light reflected from the scene 102 to the time-of-flight imaging portion 105 (to each pixel of the image sensor 105).

The light emission time and modulation information is fed to the circuitry or control 107 including a time-of-flight measurement unit 108, which also receives respective information from the time-of-flight imaging portion 105, when the light is detected which is reflected from the scene 102. On the basis of the modulated light received from the light source 101 and the performed demodulation (and the discussed demosaicking herein), the time-of-flight measurement unit 108 computes a phase shift of the received modulated light which has been emitted from the light source 101 and reflected by the scene 102 and on the basis thereon it computes a distance d (depth information) between the image sensor 105 and the scene 102, as also discussed above.

The depth information is fed from the time-of-flight measurement unit 108 to a 3D image reconstruction unit 109 of the circuitry 107, which reconstructs (generates) a 3D image of the scene 102 based on the depth information received from the time-of-flight measurement unit 108.

FIG. 11 shows a flow-chart of an embodiment of a method 120 according to the present disclosure, e.g. for controlling the time of flight device or imaging portion, as discussed herein (e.g. the ToF device 100 of FIG. 10, the ToF device 10 of FIG. 2, etc.).

In 121, second imaging element data are acquired within one exposure of a time-of-flight imaging portion.

In 122, first imaging data are constructed based on the second imaging element data based on a machine learning algorithm. In order to construct the first imaging data, the machine learning algorithm is applied to a neural network, which is trained based on a predetermined pattern of the time-of-flight imaging portion. The result of the training is provided at an analysis portion for a time-of-flight imaging device in order to construct the first imaging data.

In 123, first imaging element data are acquired within the same exposure of the time-of-flight imaging portion, but in another modulation phase than the second imaging element data.

In 124, second imaging data are constructed based on the first imaging element data with an adapted machine learning algorithm, which is similar to the machine learning algorithm of 122.

In 125, third imaging element data of is acquired within the same exposure of the time-of-flight imaging portion, but in another modulation phase than the first and second imaging element data. The third imaging element data correspond to color information.

It should be recognized that the embodiments describe methods with an exemplary ordering of method steps. The specific ordering of method steps is however given for illustrative purposes only and should not be construed as binding. For example the ordering of 24 and 26 in the embodiment of FIG. 3 may be exchanged. Also, the ordering of 26, 28 and 21 in the embodiment of FIG. 3 may be exchanged. Further, also the ordering of 93 and 94 in the embodiment of FIG. 9 may be exchanged. Other changes of the ordering of method steps may be apparent to the skilled person.

Please note that the division of the device 10 into units 12 to 13 is only made for illustration purposes and that the present disclosure is not limited to any specific division of functions in specific units. For instance, the device 10 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, wherein the analysis portion is configured to:

construct first imaging data of the at least one imaging element of the first type based on second imaging element data of the at least one imaging element of the second type, wherein the first imaging data are constructed based on a machine learning algorithm.

(2) The analysis portion according to (1), further configured to:
construct second imaging data of the at least one imaging element of the second type based on first imaging element data of the at least one imaging element of the first type, wherein the first imaging element data are based on a first modulation phase, and the second imaging element data are based on a second modulation phase.

(3) The analysis portion according to anyone of (1) or (2), wherein the time-of-flight imaging portion includes at least one imaging element of a third type, which is included in the predetermined pattern, and wherein the analysis portion is further configured to:
construct third imaging data of the at least one imaging element of the third type based on any of the first imaging element data or the second imaging element data, wherein the third imaging data indicate color information.

(4) The analysis portion according to anyone of (1) to (3), wherein any of the first imaging data or the second imaging data are further constructed based on third imaging element data.

(5) The analysis portion according to anyone of (1) to (4), wherein the machine learning algorithm is applied to a neural network.

(6) The analysis portion according to anyone of (1) to (5), wherein the neural network is trained based on the predetermined pattern.

(7) The analysis portion according to anyone of (1) to (6), wherein a function obtained by the machine learning algorithm is provided at the analysis portion.

(8) The analysis portion according to anyone of (1) to (7), wherein the first imaging data are constructed in response to one exposure of the time-of-flight imaging portion.

(9) A time-of-flight imaging device comprising:
a time-of-flight imaging portion including at least one imaging element of a first type and at least one imaging element of a second type, wherein the at least one imaging element of the first type and the at least one imaging element of the second type are arranged in a predetermined pattern; and
an analysis portion for the time-of-flight imaging portion, configured to:
construct first imaging data of the at least one imaging element of the first type based on second imaging element data of the at least one imaging element of the second type, wherein the first imaging data are constructed based on a machine learning algorithm.

(10) The time-of-flight imaging device according to (9), wherein the time-of-flight imaging portion and the analysis portion are stacked onto each other.

(11) The time-of-flight imaging device according to anyone of (9) or (10), wherein the predetermined pattern corresponds to an alternating arrangement of the at least one imaging element of the first type and the at least one imaging element of the second type.

(12) The time-of-flight imaging device according to anyone of (9) to (11), wherein the predetermined pattern is a random pattern.

(13) The time-of-flight imaging device according to anyone of (9) to (12), further comprising at least one imaging element of a third type included in the predetermined pattern indicating a color information.

(14) A method for controlling an analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, the method comprising:
constructing first imaging data of the at least one imaging element of the first type based on second imaging element data of the at least one imaging element of the second type, wherein the first imaging data are constructed based on a machine learning algorithm.

(15) The method according to (14), further comprising:
constructing second imaging data of the at least one imaging element of the second type based on first imaging element data of the at least one imaging element of the first type, wherein
the first imaging element data correspond to imaging data of a first modulation phase, and wherein
the second imaging element data correspond to imaging data of a second modulation phase.

(16) The method according to anyone of (14) or (15), wherein the time-of-flight imaging portion includes at least one imaging element of a third type, which is included in the predetermined pattern, the method further comprising:
constructing third imaging data of the at least one imaging element of the third type based on any of the first imaging element data or the second imaging element data, wherein at least
the third imaging data indicate color information, or wherein
any of the first imaging data or the second imaging data are further constructed based on third imaging element data.

(17) The method according to anyone of (14) to (16), wherein the machine learning algorithm is applied to a neural network.

(18) The method according to anyone of (14) to (17), wherein the neural network is trained based on the predetermined pattern.

(19) The method according to anyone of (14) to (18), wherein a function obtained by the machine learning algorithm for constructing the first imaging data and the second imaging data are provided at the analysis portion.

(20) The method according to anyone of (14) to (19), wherein the first imaging data are constructed in response to one exposure of the time-of-flight imaging portion.

(21) A computer program comprising program code causing a computer to perform the method according to anyone of (14) to (20), when being carried out on a computer.

(22) A non-transitory computer-readable recording medium that stores therein a computer program product, which, when executed by a processor, causes the method according to anyone of (14) to (20) to be performed.

(23) Circuitry for a time-of-flight imaging circuitry, wherein the time-of-flight imaging circuitry includes at least one imaging element of a first type and at least one imaging element of a second type, wherein the at least one imaging element of the first type and the at least one imaging element of the second type are arranged in a predetermined pattern, wherein the circuitry is configured to:
construct first imaging data of the at least one imaging element of the first type based on second imaging element data of the at least one imaging element of the second type, wherein the first imaging data are constructed based on a machine learning algorithm.

(24) The circuitry according to (23), further configured to:
construct second imaging data of the at least one imaging element of the second type based on first imaging element data of the at least one imaging element of the first type, wherein the first imaging element data are based on a first modulation phase, and the second imaging element data are based on a second modulation phase.

(25) The circuitry according to anyone of (23) or (24), wherein the time-of-flight imaging circuitry includes at least one imaging element of a third type, which is included in the predetermined pattern, and wherein the circuitry is further configured to:
construct third imaging data of the at least one imaging element of the third type based on any of the first imaging element data or the second imaging element data, wherein the third imaging data indicate color information.

(26) The circuitry according to anyone of (23) to (25), wherein any of the first imaging data or the second imaging data are further constructed based on third imaging element data.

(27) The circuitry according to anyone of (23) to (26), wherein the machine learning algorithm is applied to a neural network.

(28) The circuitry according to anyone of (23) to (27), wherein the neural network is trained based on the predetermined pattern.

(29) The circuitry according to anyone of (23) to (28), wherein a function obtained by the machine learning algorithm is provided at the circuitry.

(30) The circuitry according to anyone of (23) to (29), wherein the first imaging data are constructed in response to one exposure of the time-of-flight imaging circuitry.

(31) A time-of-flight imaging device comprising:
a time-of-flight imaging circuitry including at least one imaging element of a first type and at least one imaging element of a second type, wherein the at least one imaging element of the first type and the at least one imaging element of the second type are arranged in a predetermined pattern; and
circuitry for the time-of-flight imaging circuitry, in particular according to anyone of (23) to (29), configured to:
construct first imaging data of the at least one imaging element of the first type based on second imaging element data of the at least one imaging element of the second type, wherein the first imaging data are constructed based on a machine learning algorithm.

(32) The time-of-flight imaging device according to (31), wherein the time-of-flight imaging circuitry and the circuitry are stacked onto each other.

(33) The time-of-flight imaging device according to anyone of (31) or (32), wherein the predetermined pattern corresponds to an alternating arrangement of the at least one imaging element of the first type and the at least one imaging element of the second type.

(34) The time-of-flight imaging device according to anyone of (31) to (33), wherein the predetermined pattern is a random pattern.

(35) The time-of-flight imaging device according to anyone of (9) to (12), further comprising at least one imaging element of a third type included in the predetermined pattern indicating a color information.

(36) A method for controlling an analysis circuitry for a time-of-flight imaging circuitry, wherein the time-of-flight imaging circuitry includes at least one imaging element of a first type and at least one imaging element of a second type, wherein the at least one imaging element of the first type and the at least one imaging element of the second type are arranged in a predetermined pattern, the method comprising:
constructing first imaging data of the at least one imaging element of the first type based on second imaging element data of the at least one imaging element of the second type, wherein the first imaging data are constructed based on a machine learning algorithm.

(37) The method according to (36), further comprising:
constructing second imaging data of the at least one imaging element of the second type based on first imaging element data of the at least one imaging element of the first type, wherein
the first imaging element data correspond to imaging data of a first modulation phase, and wherein
the second imaging element data correspond to imaging data of a second modulation phase.

(38) The method according to anyone of (36) or (37), wherein the time-of-flight imaging circuitry includes at least one imaging element of a third type, which is included in the predetermined pattern, the method further comprising:
constructing third imaging data of the at least one imaging element of the third type based on any of the first imaging element data or the second imaging element data, wherein at least
the third imaging data indicate color information, or wherein
any of the first imaging data or the second imaging data are further constructed based on third imaging element data.

(39) The method according to anyone of (36) to (38), wherein the machine learning algorithm is applied to a neural network.

(40) The method according to anyone of (36) to (39), wherein the neural network is trained based on the predetermined pattern.

(41) The method according to anyone of (36) to (40), wherein a function obtained by the machine learning algorithm for constructing the first imaging data and the second imaging data are provided at the analysis circuitry.

(42) The method according to anyone of (36) to (41), wherein the first imaging data are constructed in response to one exposure of the time-of-flight imaging circuitry.

(43) A computer program comprising program code causing a computer to perform the method according to anyone of (36) to (42), when being carried out on a computer.

(44) A non-transitory computer-readable recording medium that stores therein a computer program product, which, when executed by a processor, causes the method according to anyone of (36) to (42) to be performed.

1. An analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, wherein the analysis portion is configured to:
construct first imaging data of the at least one imaging element of the first type based on second imaging element data of the at least one imaging element of the second type, wherein the first imaging data are constructed based on a machine learning algorithm.

2. The analysis portion according to claim 1, further configured to:
construct second imaging data of the at least one imaging element of the second type based on first imaging element data of the at least one imaging element of the first type, wherein the first imaging element data are based on a first modulation phase, and the second imaging element data are based on a second modulation phase.

3. The analysis portion according to claim 2, wherein the time-of-flight imaging portion includes at least one imaging element of a third type, which is included in the predetermined pattern, and wherein the analysis portion is further configured to:
construct third imaging data of the at least one imaging element of the third type based on any of the first imaging element data or the second imaging element data, wherein the third imaging data indicate color information.

4. The analysis portion according to claim 3, wherein any of the first imaging data or the second imaging data are further constructed based on third imaging element data.

5. The analysis portion according to claim 1, wherein the machine learning algorithm is applied to a neural network.

6. The analysis portion according to claim 5, wherein the neural network is trained based on the predetermined pattern.

7. The analysis portion according to claim 1, wherein a function obtained by the machine learning algorithm is provided at the analysis portion.

8. The analysis portion according to claim 1, wherein the first imaging data are constructed in response to one exposure of the time-of-flight imaging portion.

9. A time-of-flight imaging device comprising:
a time-of-flight imaging portion including at least one imaging element of a first type and at least one imaging element of a second type, wherein the at least one imaging element of the first type and the at least one imaging element of the second type are arranged in a predetermined pattern; and
an analysis portion for the time-of-flight imaging portion, configured to:
construct first imaging data of the at least one imaging element of the first type based on second imaging element data of the at least one imaging element of the second type, wherein the first imaging data are constructed based on a machine learning algorithm.

10. The time-of-flight imaging device according to claim 9, wherein the time-of-flight imaging portion and the analysis portion are stacked onto each other.

11. The time-of-flight imaging device according to claim 9, wherein the predetermined pattern corresponds to an alternating arrangement of the at least one imaging element of the first type and the at least one imaging element of the second type.

12. The time-of-flight imaging device according to claim 9, wherein the predetermined pattern is a random pattern.

13. The time-of-flight imaging device according to claim 9, further comprising at least one imaging element of a third type included in the predetermined pattern indicating a color information.

14. A method for controlling an analysis portion for a time-of-flight imaging portion, wherein the time-of-flight imaging portion includes at least one imaging element of a first type and at least one imaging element of a second type, wherein the at least one imaging element of the first type and the at least one imaging element of the second type are arranged in a predetermined pattern, the method comprising:
constructing first imaging data of the at least one imaging element of the first type based on second imaging element data of the at least one imaging element of the second type, wherein the first imaging data are constructed based on a machine learning algorithm.

15. The method according to claim 14, further comprising:
constructing second imaging data of the at least one imaging element of the second type based on first imaging element data of the at least one imaging element of the first type, wherein
the first imaging element data correspond to imaging data of a first modulation phase, and wherein
the second imaging element data correspond to imaging data of a second modulation phase.

16. The method according to claim 15, wherein the time-of-flight imaging portion includes at least one imaging element of a third type, which is included in the predetermined pattern, the method further comprising:
constructing third imaging data of the at least one imaging element of the third type based on any of the first imaging element data or the second imaging element data, wherein at least
the third imaging data indicate color information, or wherein
any of the first imaging data or the second imaging data are further constructed based on third imaging element data.

17. The method according to claim 14, wherein the machine learning algorithm is applied to a neural network.

18. The method according to claim 17, wherein the neural network is trained based on the predetermined pattern.

19. The method according to claim 14, wherein a function obtained by the machine learning algorithm for constructing the first imaging data and the second imaging data are provided at the analysis portion.

20. The method according to claim 14, wherein the first imaging data are constructed in response to one exposure of the time-of-flight imaging portion.
